(19) United States
(12) Patent Application Publication
(10) Pub. No.: US 2008/0195635 A1
(43) Pub. Date: Aug. 14, 2008

(54) PATH INDEXING FOR NETWORK DATA

(75) Inventors: Jagdish Chand, Fremont, CA (US); Suresh Antony, San Jose, CA (US); Rajesh Bhargava, Fremont, CA (US); Avanti Nadgir, Sunnyvale, CA (US); Jagannatha Narayanareddy, San Jose, CA (US)

Correspondence Address: BEYER LAW GROUP LLP/YAHOO, PO BOX 1687, CUPERTINO, CA, 95015-1687, US

(73) Assignee: YAHOO! INC., Sunnyvale, CA (US)

(21) Appl. No.: 11/673,864

(22) Filed: Feb. 12, 2007

(51) Int. Cl. G06F 17/30

(52) U.S. Cl. 707/100; 707/E17.044

(57) ABSTRACT

A solution is provided wherein path information is stored for efficient retrieval. Raw path information may be stored in a path file. A node path index file may then be created containing entries for each of one or more corresponding nodes in the path information. Each node path entry corresponds to a unique appearance of the corresponding node in the path file, and wherein each node path entry contains a path file offset and a position of the corresponding node in the path file in the path indicated by the path file offset. A node index file may then be created containing, for one or more nodes in the path information, a single node entry containing an indication of the number of times the corresponding node in the node path index file appears in the node path index file and also containing a node path index file offset.

### RELATED APPLICATION

This application is related to U.S. patent application Ser. No. ______ entitled “PATH IDENTIFICATION FOR NETWORK DATA”(Attorney Docket No. YAH1-P060), filed concurrently herewith by Jagdish Chand, Suresh Antony, Rajesh Bhargava, Avanti Nadgir, and Jagannatha Narayanareddy.

### BACKGROUND OF THE INVENTION

1. Field of the Invention

The present invention relates to network usage data. More particularly, the present invention relates to path indexing for network data.

2. Description of the Related Art

The process of analyzing Internet-based actions such as web surfing patterns is known as web analytics. One part of web analytics is understanding how user traffic flows through a network (also known as user paths). This typically involves analyzing which nodes a user encounters when accessing a particular network. In large networks such as, for example, large search engine/directories, billions of pageviews may be generated per day. As such, analyzing this huge amount of data can be daunting. Such analysis is needed, however, to determine common user behavior in order to optimize the network for better user engagement and network integration.

Due to the plentiful nature of this network data, performing analysis can be time-consuming. The identification of useful patterns can take hours or days, amounts of time that are unacceptable to most of the people interested in finding the patterns (e.g., managers, CEOs, etc.). As such, what is needed is a faster way to identify useful patterns in such a large data set.

### SUMMARY OF THE INVENTION

A solution is provided wherein path information is stored for efficient retrieval. Raw path information may be stored in a path file. A node path index file may then be created containing entries for each of one or more corresponding nodes in the path information. Each node path entry corresponds to a unique appearance of the corresponding node in the path file, and wherein each node path entry contains a path file offset and a position of the corresponding node in the path file in the path indicated by the path file offset. A node index file may then be created containing, for one or more nodes in the path information, a single node entry containing an indication of the number of times the corresponding node in the node path index file appears in the node path index file and also containing a node path index file offset.

### BRIEF DESCRIPTION OF THE DRAWINGS

FIG. 1 is a diagram illustrating the structure of files in accordance with an embodiment of the present invention.

FIG. 2 is a diagram illustrating an architecture of an indexing engine in accordance with an embodiment of the present invention.

FIG. 3 is a diagram illustrating a path file, node path index file, and a node index file for the first bucket in the above example.

FIG. 4 is a flow diagram illustrating a method for storing path information for efficient access in accordance with an embodiment of the present invention.

FIG. 5 is a flow diagram illustrating a method for efficiently accessing path information stored in a path file in accordance with an embodiment of the present invention.

FIG. 6 is a block diagram illustrating an apparatus for storing path information for efficient access in accordance with an embodiment of the present invention.

FIG. 7 is a block diagram illustrating an apparatus for efficiently accessing path information stored in a path file in accordance with an embodiment of the present invention.

FIG. 8 is an exemplary network diagram illustrating some of the platforms that may be employed with various embodiments of the invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well-known features may not have been described in detail to avoid unnecessarily obscuring the invention.

A solution is provided that efficiently indexes user paths within a large network.

Common business questions that need to be answered by analyzing a large network user path data set include:

1. What are the top paths traversed from a particular node to another particular nodes? (e.g., what paths did users commonly follow to go from Yahoo! Finance to Yahoo! Sports).

2. What are the top paths traversed from a particular node to another particular node that encompass certain paths (e.g., what paths did users commonly follow to go from Yahoo! Finance to Yahoo! Sports that included passing through Yahoo! Entertainment first).

3. What are the top paths traversed from a particular node? (e.g., what paths did users commonly follow after Yahoo! Finance).

4. What are the top nodes users left off at without reaching a destination node (starting at some node followed by a sequence of nodes)?

5. What are the top referrers for a given sequence of nodes?6. What are the nodes that have a maximum affinity to a given node?

The beginning point for various embodiments of the present invention may be a data set of visited paths. This path information may be generated by any number of mechanisms. In an embodiment of the present invention, the paths in the data set may first be evenly split into multiple buckets. A bucket is simply an abstract organizational construct connoting a grouping of information. This allows each of the buckets to be processed in parallel by one or more computers and/or processors. It should be noted that each of the buckets will typically wind up containing all the nodes in the domain set in that paths are not deliberately ordered into specific buckets. However, no limitations are placed on the possibilities for various groupings, including groupings that are made for other purposes beyond the scope of the disclosure, such as grouping certain users, geographic regions, etc. together.

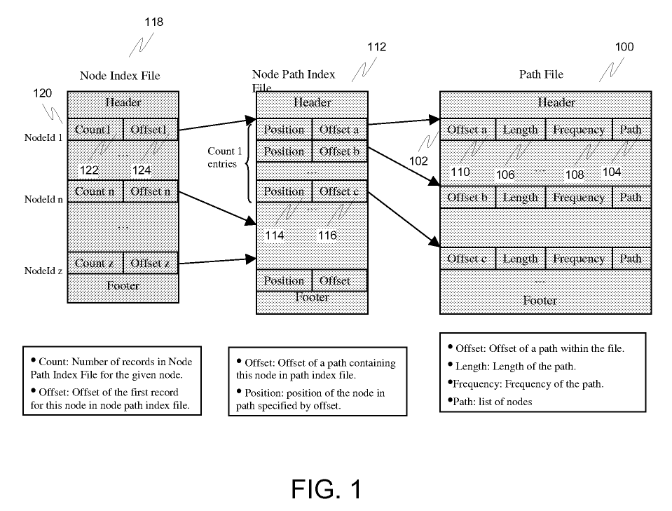

Network path information related to each of the buckets may be organized into three files: a node index file, a node path index file, and a path file. In one embodiment of the present invention these files may be in a binary format. FIG. 1 is a diagram illustrating the structure of the files in accordance with an embodiment of the present invention. Each bucket may contain one of each of these three files. The path file 100 may contain the raw path information from the data set (for the paths placed in this particular bucket). The path file may have one entry 102 for each path. Each entry may include the path itself 104 (expressed, for example, as an ordered list of nodes), information about the length of the path 106, the frequency with which the path occurred 108 (in the data corresponding to the particular bucket), and an offset 110. The offset may represent the location within the file where the entry is present (i.e., the number of entries in the file preceding the current entry). For example, if the entry 102 is the 20th entry in the file, the offset may be 19.

The node path index file 112 may contain an entry for each occurrence of a node in all the paths associated with the bucket. Each entry may carry information about that node in the corresponding path file 100. It may contain the position 114 of the node in the path and an offset 116 into the path file 100 to directly access the information about the path. This offset may also be thought of as a pointer to a particular area of the path file 100 that contains the information about the path.

The node index file 118 may contain one entry for each node that is present in the paths (i.e., a single entry for the node even if the node is present in multiple paths). An entry may also be present for a path even if the path is not present in the corresponding bucket. Each entry 120 may contain a count 122 reflecting the number of entries in the node path index file 112 for the given node. Each entry 120 may also contain an offset 124 pointing to the first entry for the node in the node path index file 112.

Given these three files, data may be accessed very quickly as only the information that is relevant is read by directly navigating to that location in the index files. For example, to obtain all the different paths users have navigated after visiting a Node N, the following method may be performed. First, the node index file 118 may be accessed to determine where the Node N is present. Once this entry is found, the offset 124 may be obtained for this node and the number of entries to be scanned may be obtained by the count 122. Then, using the offset 124, the specific entry in the node path index file 112 may be located. Starting from this entry, a number of entries equal to the retrieved count 122 may be selected. For each of these selected entries, the offsets 116 may be used to identify and extract the corresponding paths in the path file 100.

It should be noted that the use of buckets is optional. Certain implementations are envisioned wherein there are no buckets and the path file 100 contains all of the path information for the entire data set. The same may be said for the node path index file 112 and the node index file 118.

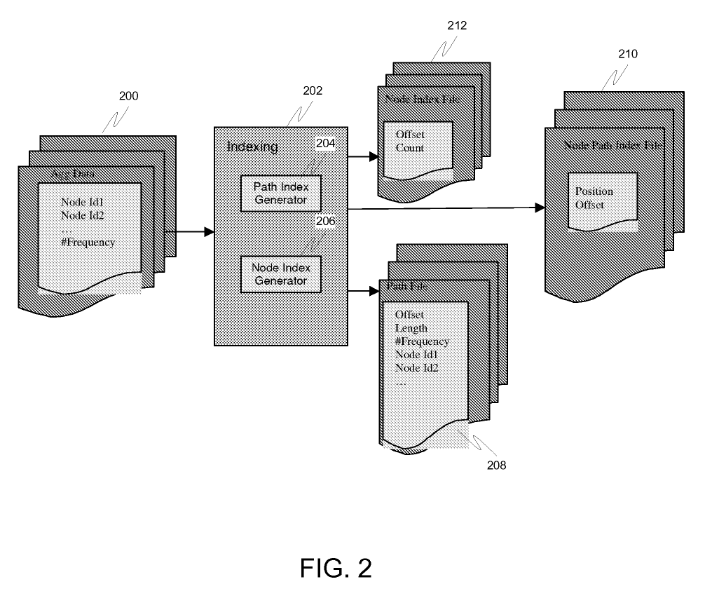

FIG. 2 is a diagram illustrating an architecture of an indexing engine in accordance with an embodiment of the present invention. Aggregated raw path data 200 and the corresponding frequencies may be passed to an indexing engine 202. The indexing engine 202 may include a path index generator 204 and a node index generator 206. The path index generator may be called for each of the individual buckets to generate a path file 208. This may include writing a binary record for each path, the record containing an offset at which it is written, as well as the length of the path and the sequence of nodes that form the path. This may be a variable sized record. Offset and position of node within each path may be tracked separately.

The node index generator 206 may then generate the node path index file 210 and the node index file 212. This process may utilize the node position and the node offset values generated by the path index generator. There may be an entry for each occurrence of a node in the node path index file 210. Each entry may have two components: path offset and the position of the node within the path. The node index file 212 may be an index into the node path index file 210 for each node.

An example is provided for illustrative purposes. This example is not intended to be limiting. Assume that the following distinct paths are in the raw input data set:

| | |
|---|---|
| 1:5:10:2 | 2 |
| 1:5:9:10 | 1 |
| 1:5:10:5 | 1 |
| 1:8:9:10:11:8 | 10 |
| 2:10:11:12 | 10 |
| 2:11:12 | 5 |

where each line indicates one distinct path having two components: the nodes in the path and the payload (frequency). Here, n₁:n₂:n₂ . . . indicates the path. Each nᵢ is the encoded integer value of the node. The number after the path is the frequency (the number of instances where the path occurs in the overall data set).

If there are three output buckets, then each bucket may get two paths. It should be noted that in real-world situations the paths are more likely to be on the order of 500 million with each path containing up to 600 nodes, but for obvious reasons such a complex example will not be described in this document.

The first bucket may contain:

| | |
|---|---|
| 1:5:10:2 | 2 |
| 1:5:9:10 | 1 |

The second bucket may contain:

| | |
|---|---|
| 1:5:10:5 | 1 |
| 1:8:9:10:11:8 | 10 |

The third bucket may contain:

| | |
|---|---|
| 2:10:11:12 | 10 |
| 2:11:12 | 5 |

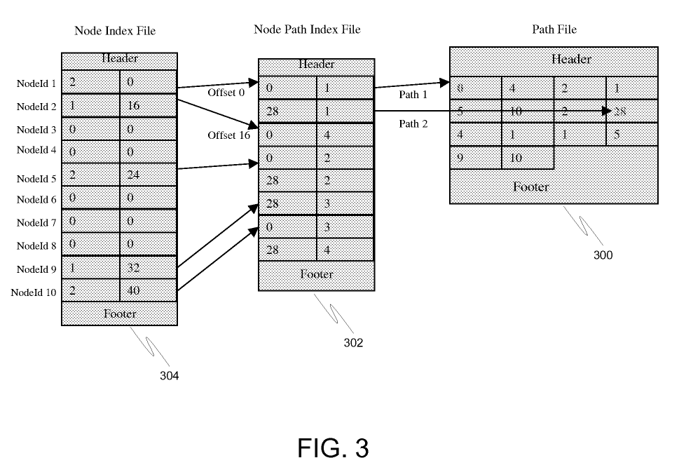

FIG. 3 is a diagram illustrating a path file, node path index file, and node index file for the first bucket in the above example. Here, the path file 300 for the first bucket contains two paths. Path file 300 begins with the sequence 0 4 2, which correspond to the offset, length, and frequency, respectively, corresponding to the first path. Then the path file 300 contains the first path itself (1 5 10 2). Then the path file 300 contains the offset, length and frequency for the second path (28 4 1) followed by the second path (1 5 9 10). Note that the second offset is 28 because the first path record has seven entries. In this example, each entry may be represented using four bytes, thus the second path information begins at the 28th byte. Alternatively, the offset may be based upon the number of the corresponding entry with respect to other entries, regardless of the size of each entry (e.g., the eighth entry may have an offset of seven).

The node path index file 302 may then contain information for each of the nodes in this bucket. The paths in this bucket have only 5 total different nodes. These are 1, 2, 5, 9, and 10. For node 1, the node appears in both paths in the bucket, as such, the node path index file contains two records for node 1. Here, the first record for node 1 contains 0 1, indicating the offset and position, respectively of the node. That is, this first record indicates that node 1 appears in the path beginning at offset 0 in the path file, in the first position in the path. Likewise, the second record (i.e., 28 1) indicates that node 1 appears in the path beginning at offset 28 in the path file, in the first position in the path. Each record in the node path index file 302 may comprise 8 bytes (four bytes each for the offset and the position).

The node index file 304 may contain information on all the nodes present in the whole data set. This may include nodes that are not present in the bucket. In an alternative embodiment, only nodes present in the bucket are represented in the node index file 304. In this example, however, nodes present in the data set but not present in the bucket have entries stored as all zeros. Each record in the node index file 304 has two components, the first one giving the number of entries for the corresponding node in the node path index file for this bucket, and the second one giving the offset at which records corresponding to the node are available in the node path index file for this bucket. Here, the entry for node 1 indicates that there are two entries in the node path index file corresponding to node 1 and these entries begin at offset 0. Likewise, the entry for node 2 indicates that there is only 1 entry in the node path index file corresponding to node 1 and the entry begins at offset 16.

Analysis of the path information in order to answer relevant business questions is simplified by use of various embodiments of the present invention. For example, a node of interest may be identified and corresponding paths containing the node may be identified using the above-described embodiments so that it is not necessary to scan through all of the path information merely to find relevant paths. Additionally, when there are two or more nodes of interest (for example, the user wishes to answer the question: what are the top paths users have navigated after visiting a first node and later visiting a second node?), the processes described above may be repeated for each node of interest. In an embodiment of the present invention, information retrieved during the process for a node of interest may be utilized to reduce the number of paths retrieved for subsequent nodes of interest. For example, if the user wishing to obtain path information for paths containing both a first node and a second node, the process may be executed normally for the first node of interest. For the second node of interest, the system may look to the node index file, obtain the proper offset for the node path index file and the number of entries to be scanned, and seek and obtain all of the starting positions (offsets) of the paths in the path index file corresponding to the second node of interest. However, the system may efficiently narrow the scope of the retrieved paths by only locating paths that were also identified during the process for the first node of interest. In other words, paths containing the second node of interest are only retrieved if they were previously identified as containing the first node of interest. This embodiment provides efficiency benefits over an alternative embodiment wherein all the paths containing the first node of interest and all the paths containing the second node of interest are retrieved and the two sets of paths are intersected.

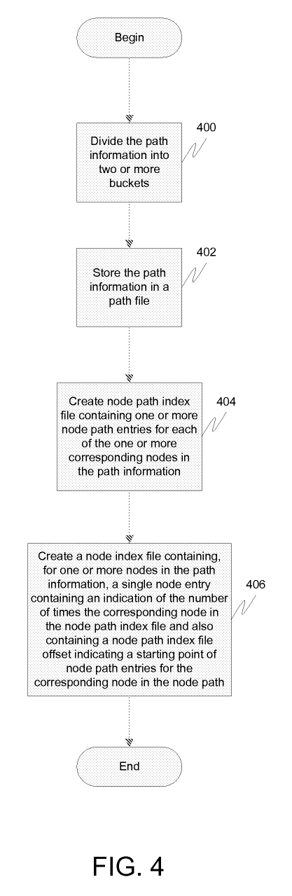

FIG. 4 is a flow diagram illustrating a method for storing path information for efficient access in accordance with an embodiment of the present invention. The path information may relate to network nodes visited by users of a computer network. At 400, the path information may be divided into two or more buckets. At 402, the path information may be stored in a path file. This may include storing the path information in its own path file for each of the buckets. At 404, a node path index file containing one or more node path entries for each of the one or more corresponding nodes in the path information may be created. Each node path entry may correspond to a unique appearance of the corresponding node in the path file. Each node path entry may contain a path file offset indicating a starting point of a path containing the corresponding node in the path file. Additionally, each node path entry may further contain a position of the corresponding node in the path file in the path indicated by the path file offset.

At 406, a node index file may be created containing, for one or more nodes in the path information, a single node entry containing an indication of the number of times the corresponding node appears in the corresponding node path index file and also containing a node path index file offset indicating a starting point of the node path entries for the corresponding node in the node path index file. If buckets are utilized, then the node index file may or may not contain entries related to nodes in paths not contained in this bucket (i.e., nodes that only appear in paths in other buckets).

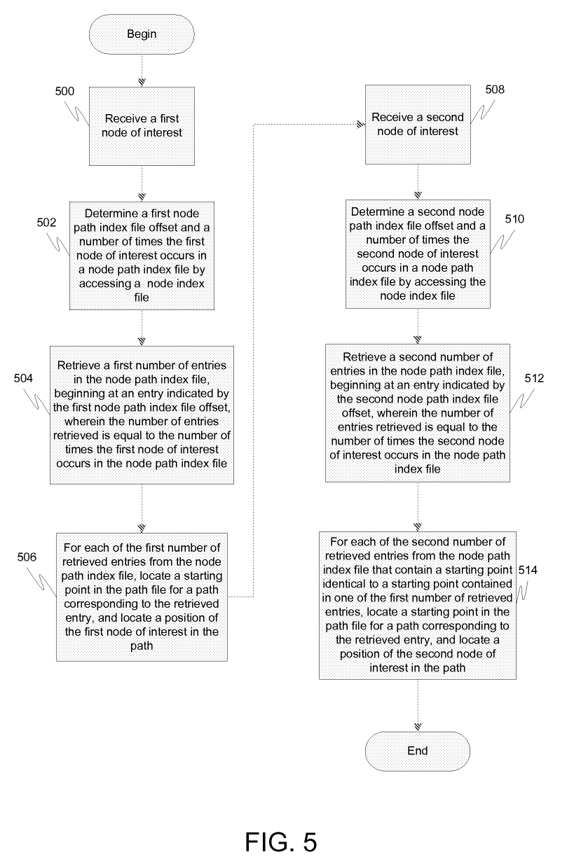

FIG. 5 is a flow diagram illustrating a method for efficiently accessing path information stored in a path file in accordance with an embodiment of the present invention. The path information may relate to network nodes visited by users of a computer network. At 500, a first node of interest may be received. This may be received directly from a user, or from a software component. The software component may, for example, be interpreting natural language (e.g., English) queries from a user or other source and extracting nodes of interest from the queries. At 502, a first node path index file offset and a number of times the first node of interest occurs in a node path index file may be determined by accessing a node index file. The node index file may contain, for one or more corresponding nodes in the path information, a single node entry containing an indication of the number of times the first node of interest appears in the node path index file and also containing an offset into a node path index file indicating a starting point of node path entries for the first node of interest.

At 504, a first number of entries in the node path index file may be retrieved, beginning at an entry indicated by the first node path index file offset, wherein the number of entries retrieved is equal to the number of times the first node of interest occurs in the node path index file. The node path index file may contain one or more node path entries for each of one or more corresponding nodes in the path information, wherein each node path entry corresponds to a unique appearance of the corresponding node in the path file, and wherein each node path entry contains a path file offset indicating a starting point of a path containing the corresponding node, and wherein each node path entry further contains a position of the corresponding node in the path indicated by the path file offset.

At 506, for each of the first number of retrieved entries from the node path index file, a starting point may be located in the path file for a path corresponding to the retrieved entry, and a position of the first node of interest in the path may be located.

If the underlying query being answered involves more than one node of interest, then the following steps may be executed for a second node of interest. At 508, a second node of interest may be received. At 510, a second node path index file offset and a number of times the second node of interest occurs in the node path index file may be determined by accessing the node index file. At 512, a second number of entries in the node path index file may be retrieved, beginning at an entry indicated by the second node path index file offset, wherein the number of entries retrieved is equal to the number of times the second node of interest occurs in the node path index file. At 514, for each of the second number of retrieved entries from the node path index file that contain a starting point identical to a starting point contained in one of the first number of retrieved entries, a starting point for a path corresponding to the retrieved entry in the path file and a position of the second node of interest in the path may be retrieved.

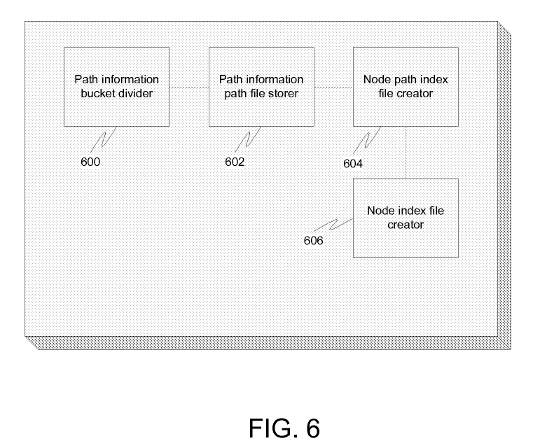

FIG. 6 is a block diagram illustrating an apparatus for storing path information for efficient access in accordance with an embodiment of the present invention. The path information may relate to network nodes visited by users of a computer network. A path information bucket divider 600 may divide the path information into two or more buckets. A path information path file storer 602 coupled to the path information bucket divider 600 may store the path information in a path file. This may include storing the path information in its own path file for each of the buckets. A node path index file creator 604 coupled to the path information path file storer 602 may create a node path index file containing one or more node path entries for each of the one or more corresponding nodes in the path information. Each node path entry may correspond to a unique appearance of the corresponding node in the path file. Each node path entry may contain a path file offset indicating a starting point of a path containing the corresponding node in the path file. Additionally, each node path entry may further contain a position of the corresponding node in the path file in the path indicated by the path file offset.

A node index file creator 606 coupled to the node path index file creator 604 may create a node index file containing, for one or more nodes in the path information, a single node entry containing an indication of the number of times the corresponding node appears in the corresponding node path index file and also containing a node path index file offset indicating a starting point of the node path entries for the corresponding node in the node path index file. If buckets are utilized, then the node index file may or may not contain entries related to nodes in paths not contained in this bucket (i.e., nodes that only appear in paths in other buckets).

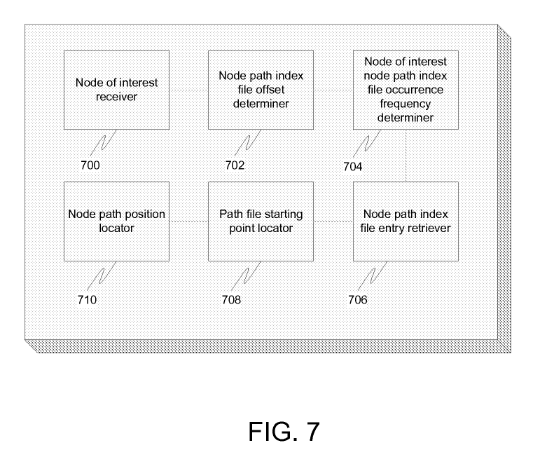

FIG. 7 is a block diagram illustrating an apparatus for efficiently accessing path information stored in a path file in accordance with an embodiment of the present invention. The path information may relate to network nodes visited by users of a computer network. A node of interest receiver 700 may receive a first node of interest. This may be received directly from a user, or from a software component. The software component may, for example, be interpreting natural language (e.g., English) queries from a user or other source and extracting nodes of interest from the queries. A node path index file offset determiner 702 coupled to the node of interest receiver 700 may determine a first node path index file offset by accessing a node index file. A node of interest node path index file occurrence frequency determiner 704 coupled to the node path index file offset determiner 702 may determine a number of times the first node of interest occurs in a node path index file by accessing the node index file. The node index file may contain, for one or more corresponding nodes in the path information, a single node entry containing an indication of the number of times the first node of interest appears in the node path index file and also containing an offset into a node path index file indicating a starting point of node path entries for the first node of interest.

A node path index file entry retriever 706 coupled to the node of interest node path index file occurrence frequency determiner 704 may retrieve a first number of entries in the node path index file, beginning at an entry indicated by the first node path index file offset, wherein the number of entries retrieved is equal to the number of times the first node of interest occurs in the node path index file. The node path index file may contain one or more node path entries for each of one or more corresponding nodes in the path information, wherein each node path entry corresponds to a unique appearance of the corresponding node in the path file, and wherein each node path entry contains a path file offset indicating a starting point of a path containing the corresponding node, and wherein each node path entry further contains a position of the corresponding node in the path indicated by the path file offset.

A path file starting point locator 708 coupled to the node path index file entry retriever 706 may locate, for each of the first number of retrieved entries from the node path index file, a starting point in the path file for a path corresponding to the retrieved entry. A node path position locator 710 coupled to the path file starting point locator 708 may locate, for each of the first number of retrieved entries from the node path index file, a position of the first node of interest in the path(s) identified in 708.

If the underlying query being answered involves more than one node of interest, then the following steps may be executed for a second node of interest. A second node of interest may be received by the node of interest receiver 700. A second node path index file offset and a number of times the second node of interest occurs in the node path index file may be determined by accessing the node index file using the node path index file offset determiner 702 and the node of interest node path index file occurrence frequency determiner 704, respectively. A second number of entries in the node path index file may be retrieved, beginning at an entry indicated by the second node path index file offset, wherein the number of entries retrieved is equal to the number of times the second node of interest occurs in the node path index file, using the node path index file entry retriever 706. For each of the second number of retrieved entries from the node path index file that contain a starting point identical to a starting point contained in one of the first number of retrieved entries, a starting point for a path corresponding to the retrieved entry in the path file and a position of the second node of interest in the path may be retrieved by the path file starting point locator 708 and the node path position locator 710, respectively.

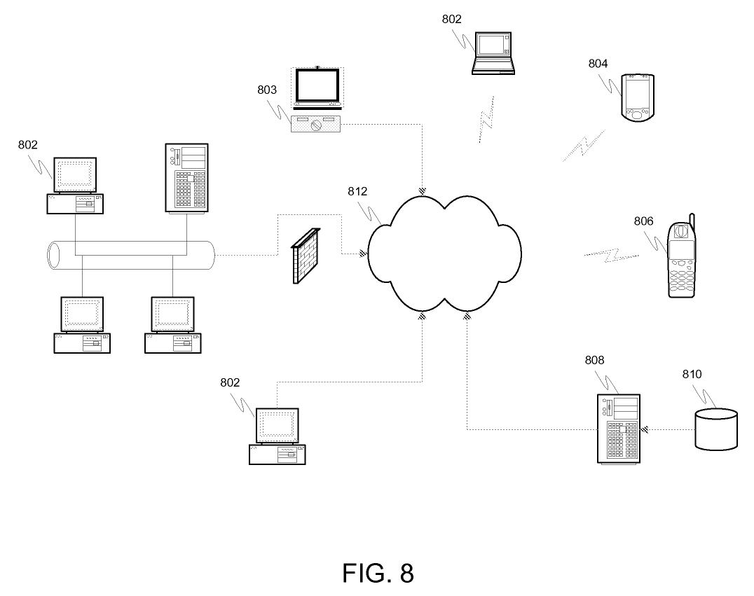

It should also be noted that the present invention may be implemented on any computing platform and in any network topology in which search categorization is a useful functionality. For example and as illustrated in FIG. 8, implementations are contemplated in which the node path files described herein is employed in a network containing personal computers 802, media computing platforms 803 (e.g., cable and satellite set top boxes with navigation and recording capabilities (e.g., Tivo)), handheld computing devices (e.g., PDAs) 804, cell phones 806, or any other type of portable communication platform. Users of these devices may navigate the network, and path information may be collected by server 808. Server 808 may then utilize the various techniques described above to store and access path information in an efficient manner. Applications may be resident on such devices, e.g., as part of a browser or other application, or be served up from a remote site, e.g., in a Web page, (represented by server 808 and data store 810). The invention may also be practiced in a wide variety of network environments (represented by network 812), e.g., TCP/IP-based networks, telecommunications networks, wireless networks, etc.

While the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A method for storing path information for efficient access, wherein the path information relates to network nodes visited by users of a computer network, the method comprising:
storing the path information in at least one path file;
creating at least one node path index file containing one or more node path entries for each of the nodes in the path information, wherein each node path entry corresponds to a unique appearance of the corresponding node in the path file, and wherein each node path entry contains a path file offset indicating a starting point of a path containing the corresponding node in the path file, and wherein each node path entry further contains a position of the corresponding node in the path file in the path indicated by the path file offset; and
creating at least one node index file containing, for one or more nodes in the path information, a single node entry containing an indication of a number of times the corresponding node in the node path index file appears in the node path index file and also containing a node path index file offset indicating a starting point of node path entries for the corresponding node in the node path.

2. The method of claim 1, further comprising:
dividing the path information into two or more buckets prior to storing the path information in a path file.

3. The method of claim 2, wherein the storing the path information includes storing the path information in its own path file for each of the buckets.

4. The method of claim 3, wherein a single path file, node path index file, and node index file are created for each of the buckets.

5. The method of claim 4, wherein the node index file further contains one or more entries corresponding to nodes appearing in the path information corresponding to a different bucket but not appearing in the path information corresponding to the bucket for the node index file.

6. The method of claim 4, wherein the node index file only contains entries corresponding to nodes appearing in the path information corresponding to the bucket for the node index file.

7. A method for efficiently accessing path information stored in a path file, wherein the path information relates to network nodes visited by users of a computer network, the method comprising:
receiving a first node of interest;
determining a first node path index file offset and a number of times the first node of interest occurs in a node path index file by accessing a node index file;
retrieving a first number of entries in the node path index file, beginning at an entry indicated by the first node path index file offset, wherein the number of entries retrieved is equal to the number of times the first node of interest occurs in the node path index file; and
for each of the first number of retrieved entries from the node path index file, locating a starting point, in the path file, for a path corresponding to the retrieved entry and locating a position of the first node of interest in the path.

8. The method of claim 7, wherein the node index file contains, for one or more corresponding nodes in the path information, a single node entry containing an indication of the number of times the first node of interest appears in the node path index file and also containing an offset into a node path index file indicating a starting point of node path entries for the first node of interest.

9. The method of claim 8, wherein the node path index file contains one or more node path entries for each of one or more corresponding nodes in the path information, wherein each node path entry corresponds to a unique appearance of the corresponding node in the path file, and wherein each node path entry contains a path file offset indicating a starting point of a path containing the corresponding node, and wherein each node path entry further contains a position of the corresponding node in the path indicated by the path file offset

10. The method of claim 7, wherein the first node of interest is received from a user.

11. The method of claim 7, wherein the first node of interest is received from a software component.

12. The method of claim 7, further comprising:
receiving a second node of interest;
determining a second node path index file offset and a number of times the second node of interest occurs in the node path index file by accessing the node index file;
retrieving a second number of entries in the node path index file, beginning at an entry indicated by the second node path index file offset, wherein the number of entries retrieved is equal to the number of times the second node of interest occurs in the node path index file; and
for each of the second number of retrieved entries from the node path index file that contain a starting point identical to a starting point contained in one of the first number of retrieved entries, locating a starting point, in the path file, for a path corresponding to the retrieved entry and locating a position of the second node of interest in the path.

13. An apparatus for storing path information for efficient access, wherein the path information relates to network nodes visited by users of a computer network, the apparatus comprising:
a path information path file storer;
a node path index file creator coupled to the path information path storer; and
a node index file creator coupled to the node path index file creator.

14. An apparatus for efficiently accessing path information stored in a path file, wherein the path information relates to network nodes visited by users of a computer network, the apparatus comprising:
a node of interest receiver;
a node path index file offset determiner coupled to the node of interest receiver;
a node of interest node path index file occurrence frequency determiner coupled to the node path index file offset determiner;
a node path index file entry retriever coupled to the node of interest node path index file occurrence frequency determiner;
a path file starting point locator coupled to the node path index file entry retriever; and
a node path position locator coupled to the path file starting point determiner.

15. An apparatus for storing path information for efficient access, wherein the path information relates to network nodes visited by users of a computer network, the apparatus comprising:
means for storing the path information in at least one path file;
means for creating at least one node path index file containing one or more node path entries for each of the nodes in the path information, wherein each node path entry corresponds to a unique appearance of the corresponding node in the path file, and wherein each node path entry contains a path file offset indicating a starting point of a path containing the corresponding node in the path file, and wherein each node path entry further contains a position of the corresponding node in the path file in the path indicated by the path file offset; and
means for creating at least one node index file containing, for one or more nodes in the path information, a single node entry containing an indication of a number of times the corresponding node in the node path index file appears in the node path index file and also containing a node path index file offset indicating a starting point of node path entries for the corresponding node in the node path.

16. An apparatus for efficiently accessing path information stored in a path file, wherein the path information relates to network nodes visited by users of a computer network, the apparatus comprising:
means for receiving a first node of interest;
means for determining a first node path index file offset and a number of times the first node of interest occurs in a node path index file by accessing a node index file;
means for retrieving a first number of entries in the node path index file, beginning at an entry indicated by the first node path index file offset, wherein the number of entries retrieved is equal to the number of times the first node of interest occurs in the node path index file; and
means for, for each of the first number of retrieved entries from the node path index file, locating a starting point, in the path file, for a path corresponding to the retrieved entry and locating a position of the first node of interest in the path.

17. A program storage device readable by a machine, tangibly embodying a program of instructions executable by the machine to perform a method for storing path information for efficient access, wherein the path information relates to network nodes visited by users of a computer network, the method comprising:
storing the path information in at least one path file;
creating at least one node path index file containing one or more node path entries for each of the nodes in the path information, wherein each node path entry corresponds to a unique appearance of the corresponding node in the path file, and wherein each node path entry contains a path file offset indicating a starting point of a path containing the corresponding node in the path file, and wherein each node path entry further contains a position of the corresponding node in the path file in the path indicated by the path file offset; and
creating at least one node index file containing, for one or more nodes in the path information, a single node entry containing an indication of a number of times the corresponding node in the node path index file appears in the node path index file and also containing a node path index file offset indicating a starting point of node path entries for the corresponding node in the node path.

18. A program storage device readable by a machine, tangibly embodying a program of instructions executable by the machine to perform a method for efficiently accessing path information stored in a path file, wherein the path information relates to network nodes visited by users of a computer network, the method comprising:
receiving a first node of interest;
determining a first node path index file offset and a number of times the first node of interest occurs in a node path index file by accessing a node index file;
retrieving a first number of entries in the node path index file, beginning at an entry indicated by the first node path index file offset, wherein the number of entries retrieved is equal to the number of times the first node of interest occurs in the node path index file; and
for each of the first number of retrieved entries from the node path index file, locating a starting point, in the path file, for a path corresponding to the retrieved entry and locating a position of the first node of interest in the path.
